(19) United States
(12) Patent Application Publication
(10) Pub. No.: US 2014/0062179 A1
(43) Pub. Date: Mar. 6, 2014

(54) Switching system for trailer lights

(71) Applicant: Bruce Torell, Willmar, MN (US)

(72) Inventor: Bruce Torell, Willmar, MN (US)

(73) Assignee: Leaders Manfacturing, Inc., Willmar, MN (US)

(21) Appl. No.: 13/598,047

(22) Filed: Aug. 29, 2012

(51) Int. Cl. B60L 1/00

(52) U.S. Cl. 307/9.1

(57) ABSTRACT

This disclosure describes a system for disconnecting electrical current between a vehicle and a trailer such as a boat trailer. A switch is positioned on the boat trailer and is conductivity connected to the electrical connection between the vehicle and the trailer. A receiver is also mounted on the boat trailer and is connected to the switch. The receiver is configured to active and deactivate the switch via a remote controller.

### BACKGROUND OF THE INVENTION

The present invention relates to an electronic device used for controlling the electrical power between a vehicle and a trailer that is being towed, in particular a trailer used to launch, retrieve and carry a boat.

Boat trailers are used to launch and retrieve a boat from a body of water. A boat trailer typically has an electrical system that is connected to the electrical system of a car. In most states, the trailer has to be equipped with running lights, stop lights and turning signal lights. Such lights, at the very least have to be on during nighttime hours while towing the trailer. The vehicle is generally equipped with a connector, either female or male that provides electrical power when connected to an opposing female or male connector which is connected to the trailer lighting system. The opposing female or male connector is external to the vehicle.

Traditionally, a rear portion of the trailer necessarily is submerged in the body of water for a portion of time during launch and retrieval. During carriage of the boat to the body of water, the trailer is towed by a vehicle and the boat trailer utilizes the electrical system of the vehicle as a means of operating the boat trailer lighting system. The tail lights of the trailer lights on the boat trailer are usually the first portion of the trailer submerged into the body of water during launch and retrieval.

A condition that can damage the light bulbs in the tail lights is created when the boat trailer is submerged. New boat trailer lights are designed to be waterproof. However, over time, the casings on the trailer lights become damaged, or at the very least lose their waterproofing during normal use. The casing may develop cracks or become loosened and allow water to enter the casing. When the cracked or loosened light casings are submerged during launch and retrieval, water damages the bulbs if the lights are still on and/or warm. Contact with the water may also result in blown fuses on the towing vehicle and/or boat trailer. The individual light bulbs generally need to be replaced after the boat trailer is submerged in the water in order for the lights to work again during towing.

To avoid cracking the bulbs of the boat trailer lights or blowing the fuse, the vehicle operator needs to remember before backing the boat trailer into the water that the boat lights are connected to the vehicle running lights. The vehicle needs to be stopped and the vehicle operator or a passenger needs to get out and go to the back of the vehicle and disconnect female/male connectors between the boat trailer lights and the vehicle. It is also a good idea to wait before backing the boat trailer into the water until the light bulbs cool sufficiently so that if the trailer lights do take on water, the bulbs will not be damaged. In addition, when retrieving the boat from the water using the trailer, the trailer lights can only be reconnected with the boat once the trailer is taken out of the water. Sometimes at the end of a boating day this detail can easily be forgotten.

### SUMMARY

This disclosure describes a system for disconnecting electrical power between a vehicle and a trailer such as a boat trailer. A switch is positioned on the boat trailer and is conductively connected to the electrical connection between the vehicle and the trailer. A receiver is also mounted on the boat trailer and is connected to the switch. The receiver is configured to activate and deactivate the switch via a remote controller.

### DRAWINGS

FIG. 1 is a perspective view of a vehicle connected to a boat trailer carrying a boat near a body of water using the device of this disclosure.

FIG. 2 is a schematic view of the receiver and remote control.

FIG. 3 is a perspective view of the receiver unit, illustrating electrical connections.

### DETAILED DESCRIPTION OF THE INVENTION

This disclosure describes a remote controlled circuit system that eliminates the need for physical detachment of the external female and male connectors between a vehicle and a boat trailer. The remote controlled circuit system of this disclosure is mountable to the tow bar or trailer tongue of a boat trailer. It is installed without any special programming requirement. The system is adaptable to the boat trailer's existing standard four-pole connector wiring harness while eliminating the need to physically detach the external female and male connectors between the vehicle and the boat.

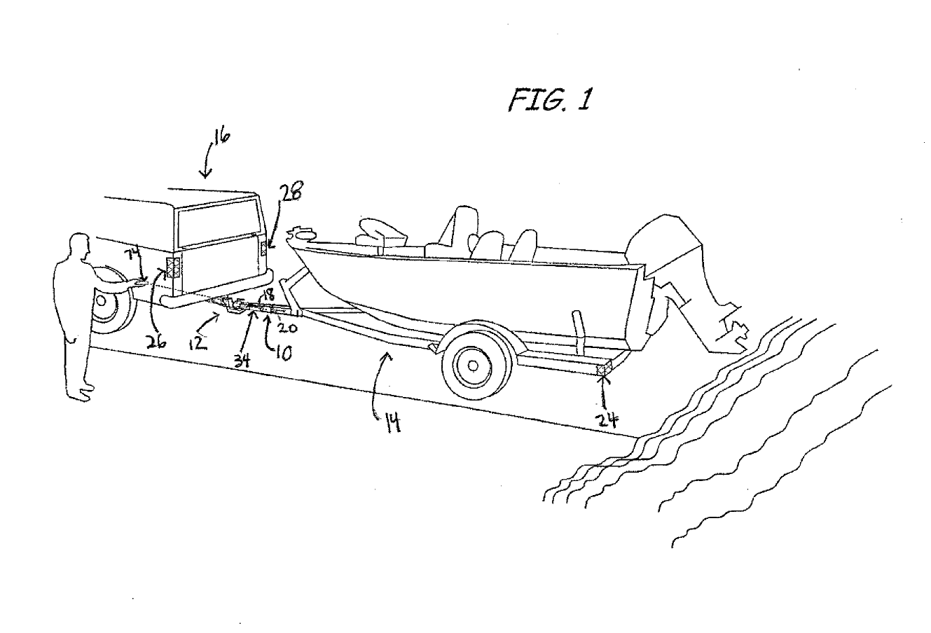

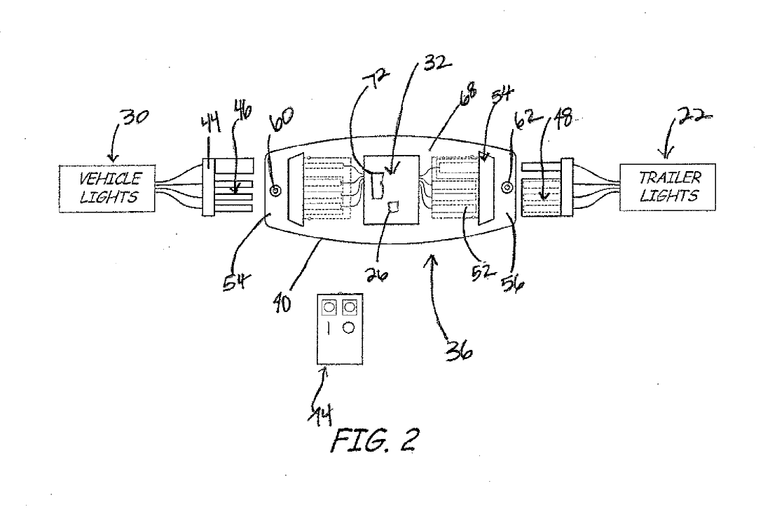

Referring to FIG. 1, the electrical device of this disclosure is generally indicated at 10. A hitch generally indicated at 12 mechanically connects a boat trailer 14 to a vehicle 16. The vehicle 16 is electrically connected to the boat trailer 14 via standard female/male connectors 18 and 20 (sometimes referred to herein as “wiring harness”) to provide current to the boat trailer lighting system 22 as represented in FIG. 2.

The lighting system 22 of a typical boat trailer including the boat trailer 14 illustrated in the drawings includes brake lights, turn signals and running lights, all represented by reference character 24 in FIG. 1. The brake lights, turn signals and running lights 24 are only shown on the left hand side of the boat trailer 14 and it is understood that there is a complimentary right hand light casing on the boat trailer that includes a brake light, turn signal and running light. The boat trailers brake lights, turn signals and running lights correspond to the vehicle's 16 brake lights, running lights and turn signals which are represented by light casings 26 and 28. Therefore, when connected, the vehicle's 16 brake lights are activated, the boat trailer's 14 brake lights are also activated. Similarly, when the vehicle's 16 running lights are turned on, the boat trailer's 14 running lights are turned on. Likewise, when either the right or left turn signal of the vehicle 16 is activated, the corresponding right or left turn signal of the boat trailer 14 is also activated. To switch off the prior art electrical connection between the boat trailer 14 and the vehicle 16, either the driver or the passenger, if one is present, has to exit the vehicle 16 and physically disconnect the male and the female lighting connectors from each other.

This disclosure describes a system that switches off the boat trailer 14 lighting system 22 while the vehicle 16 lighting system 30 remains operational. An operator controls the state of operation of the boat trailer lighting system 22 via operation of the device 10, which is located on the boat trailer 14. The operator can be the driver of the vehicle 16 and need not exit the vehicle to switch off the trailer lighting.

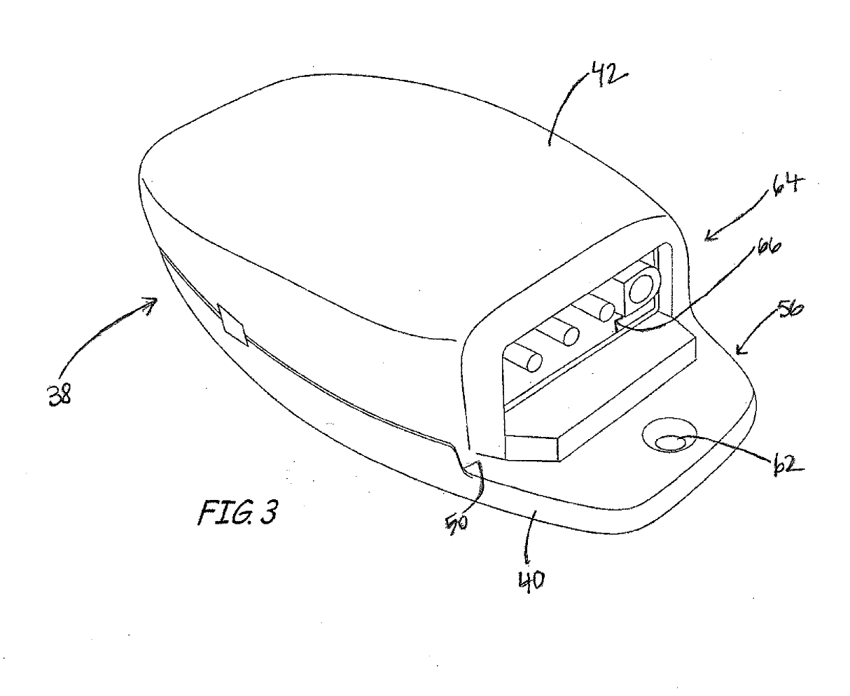

As further illustrated in FIGS. 2 and 3, an embodiment of this disclosure comprises a receiver unit 36 that is mounted onto a tow bar or tongue 34 of the boat trailer 14. The receiver unit 36 includes a housing 38 that is configured for easy mounting on the tow bar or tongue 34 of the boat trailer 14 and an electronic module 32 for controlling a flow of electrical power.

The housing 38 comprises a base wall 40 and a cover 42 as best illustrated in FIG. 3. The base wall 40 and cover 42 have substantially smooth outside surfaces. The base wall 40 has a grooved raised edge along both longitudinal lengths. The cover 42 is significantly concave in relation to the base wall 40 of the housing 38, with a raised lip 50 running along both longitudinal edges. When the cover 42 is connected to the base wall 40 the enclosure is secured by the interlocking of the longitudinal edges of the cover 42 and the base wall 40. The interlocking of edges of the base wall 40 and the cover 42 also render the housing 38 water-tight, protecting the internal components for exposure to water during boat launch and retrieval.

The base wall 40 extends longitudinally on both sides 54 and 56 beyond the cover 42 as a means of removably attaching the housing 38 to a tow bar or trailer tongue 34. Each extended side portion 54 and 56 of the base wall 40 is adapted with a hole 60 and 62 which allows for attachment of the housing 38, and thus the receiver unit 36, to the tow bar or trailer tongue 34 as discussed further below.

The latitudinal edge 64 of the cover 42 is comprised of an angular riser adapted with a series of four holes 66 which allow a four pole trailer light wiring system 22 to connect to the electronic module 32 inside the housing 38 of the receiver unit 36 via a wiring harness. A substantially identical series of four holes (not shown) on the identical opposing longitudinal edge (not shown) of the cover 42 mates to the four pole vehicle lights 30 wiring system. The wiring harnesses are connected simultaneously into the receiver unit 36 to complete current flow. For example, the receiver unit 36 can be adapted to a 4-pole connector in order to accommodate a typical boat trailer wiring harness and vehicle wiring system.

The housing 38 contains the electronic module 32 for controlling flow of current from the vehicle's lighting system 30 to the boat trailer's lighting system 22, as best illustrated in FIG. 2. The electrical connection is comprised generally of an electrical circuit 74 and an operating switch 26. The housing 38 further includes standard conductive female sockets for receiving male conductive counterparts 46 of male connector 44 of the vehicle lighting system 30. On an opposite end of the housing 38, male conductive connectors 48 are insertable into female conductive sockets 52 of female connector 54 of the boat trailer lighting system 22. If the female/male connectors of the vehicle and boat trailer lighting system are reversed, the position of the device may be turned 180 degrees to accommodate the connectors.

The conductive sockets are connected by wiring through an 8 bit micro-controller 72. Other appropriate electronic controllers may be used. The micro-controller 72 and switch 26 are easily installed to connect the vehicle wiring to the boat trailer wiring via the pre-existing wiring harnesses for the lighting systems of the boat trailer and the vehicle. The micro-controller 72 is wired to and controlled by the operation of the operating switch 26. The micro-controller 72 is secured to the inside surface 68 of the base wall 40. The electrical connection comprised generally of the electrical circuit 74 and the operating switch 26 can be configured for two operating states, “on” and “off”. In the “on” operating state, the electrical power flows continuously between the input connection and the output connection and the boat trailer lights. In the “off” operating state, the operating switch 26 interrupts the flow of electrical power from the vehicle lights 30 to the trailer lights 22. In the “off” state, no electrical power flows to the boat trailer lights.

No screws or other similar types of hardware are needed to secure the receiver unit 38 to the tow bar or trailer tongue 34. The receiver unit 38 is mounted to the boat trailer's tow bar or tongue 34 through the use of fitted straps 74 and 76, sometimes known as “cable ties” or “zip ties”. The straps 74 and 76 connect the base wall 34 to the tow bar or trailer tongue 58. The straps 74 and 76 are attached to the base wall 34 at holes 30 and 62 and are simultaneously wrapped around the tow bar or trailer tongue 58. The receiver unit 28 can be easily removed or moved, or used with various trailers without having to drill holes or otherwise adapt the tow bar or trailer tongue. Of course, screws or bolts can be used by inserting the screws or bolts through apertures 36 and into the trailer tongue or tow bar 34.

Construction of the receiver unit 28 and its mounting mechanism allow for the entire wiring connection and switch 26 to be contained within the receiver unit 28 and attached to the actual tow bar or trailer tongue 58 of the boat trailer 14. Placement of the electrical module 30 and operational switch 26 on the actual trailer tongue 58 allows for quick installation of the switch 26 without special programming or wiring harness adapters. The location also allows for easy and quick access to and connection with the existing wiring harness of the boat trailer.

One purpose of the present invention is to eliminate the traditional method of manually unplugging the boat trailer from the vehicle before launching the boat and then re-connecting the wiring harness before travel on the road. The switch 26 used for turning the lights on a boat trailer on and off by disrupting the current from the vehicle's lighting system, is activated or deactivated by use of a portable remote 74. The remote 74 sends a signal wirelessly to the receiver unit 38 mounted on the boat trailer 14, where the electrical module 32 inside the receiver unit 38 allows for the signal to activate the switch 26 and in turn the micro-controller 72 to turn the power (e.g. 12 volt) on and off as desired by the operator. The remote 74 may be handheld, attached to a buoyant key ring, or attached to a person, or kept in the vehicle.

Although the present invention has been described with reference to preferred embodiments, workers skilled in the art will recognize that changes may be made in form and detail without departing from the spirit and scope of the invention.

What is claimed is:

1. A system for controlling the electrical current from a vehicle to a trailer, the system comprising:
an electrical connection from the vehicle to the trailer;
a switch positioned on the trailer for controlling the passage of current between the vehicle and the trailer;
a receiver positioned on the trailer and connected to the switch, configured to activate and deactivate the switch via a remote controller.

2. The system of claim 1 wherein the remote controller wirelessly communicates with the receiver.

3. The system of claim 1 wherein the remote controller communicates with the receiver via a wired connection.

4. The system of claim 1 wherein the switch controls a light on the trailer.

5. The system of claim 1 wherein the trailer is a boat trailer.

6. The system of claim 1 wherein the switch controls a light on the boat trailer.

7. The system of claim 1 wherein the remote controller is operable from within the vehicle.

8. The system of claim 1, wherein the receiver is mounted on a tow bar of a boat trailer.

9. The system of claim 1, wherein the receiver connected to the switch is additionally configured to activate and deactivate the switch via a water sensor.

10. A system for controlling the electrical current from a vehicle to a boat trailer, the system comprising:
an electrical connection from the vehicle to the boat trailer, with a proximate connection configured for connection to a vehicle electrical system, and a distal connection configured for connection to a boat trailer electrical lighting system controlling a light on the boat trailer;
a switch controlling the passage of current between the vehicle and the boat trailer; and
a receiver connected to the switch, configured to activate and deactivate the switch via a remote controller.

11. The system of claim 10, wherein the remote controller wirelessly communicates with the receiver.

12. The system of claim 10, wherein the receiver is mounted on a tow bar of the boat trailer.
